(19) United States
(12) Patent Application Publication
(10) Pub. No.: US 2025/0235837 A1
(43) Pub. Date: Jul. 24, 2025

(54) HIGH-SHEAR MIXING CHAMBER WITH A WIDE SLOT CHANNEL HAVING A STEPPED INTERIOR

(71) Applicant: IDEX MPT INC., Westwood, MA (US)

(72) Inventors: Steven Mesite, Bedford, MA (US); Yang SU, Newton, MA (US)

(73) Assignee: IDEX MPT INC., Westwood, MA (US)

(21) Appl. No.: 18/856,460

(22) PCT Filed: Mar. 27, 2023
(86) PCT No.: PCT/US2023/016427

§ 371 Date: Oct. 11, 2024

Related U.S. Application Data
(60) Provisional application No. 63/324,366, filed on Mar. 28, 2022.

(51) Int. Cl. B01F 33/301; B01F 23/41; B01F 23/45; B01F 25/441

(52) U.S. Cl. CPC B01F 33/3017; B01F 23/4105; B01F 23/45; B01F 25/4412; B01F 2215/0431; B01F 2215/0468

(57) ABSTRACT

A high-shear mixing chamber is provided having a single wide slot microchannel that enables a higher throughput, less plugging, and a longer life (e.g., less wear) than typical multi-slotted mixing chambers. The provided mixing chamber may include an inlet and an outlet in fluid communication with a single wide slot microchannel (e.g., via an inlet and outlet plenum). In some aspects, the wide slot microchannel may have a stepped interior such that the wide slot microchannel has portions with different depths. The wide slot microchannel has a first surface opposite a second surface and one or more steps may be formed with the first surface alone, the second surface alone, or with both the first surface and the second surface. The steps may extend a full length of the microchannel between the inlet and outlet chambers.

### CROSS-REFERENCE TO RELATED APPLICATIONS

This application is a U.S. National Stage of International PCT Application No. PCT/US2023/016427 filed on Mar. 27, 2023, which claims priority to U.S. patent application No. 63/324,366 filed Mar. 28, 2022, the entire disclosures of both of which applications are incorporated herein by reference.

### BACKGROUND

High-shear mixing chambers typically operate by flowing fluid from one or more inlet cylinders, through one or more microchannels, and out one or more outlet cylinders. Some high-shear mixing chambers may be multi-slotted such that fluid flows through an inlet cylinder, through an inlet plenum, through multiple individual microchannels, through an outlet plenum, and out an outlet cylinder. The transition of the fluid flow into the microchannels can lead to cavitation, a physical phenomenon of formation of vapor cavities (bubbles) inside a liquid. Cavitation is the consequence of rapid changes in pressure. When pressure drops below a vaporization pressure, liquid boils and forms vapor bubbles.

There are several disadvantages associated with cavitation inside a microchannel. First, the cavities can implode as the fluid pressure recovers downstream and can generate an intense shockwave. This can cause significant damage to the internal surface of the high-shear mixing chamber and downstream piping (e.g., the wear of the components that greatly reduces chamber performance and life). Cavitation can also introduce local high temperature spots, causing damage to certain heat sensitive materials. Second, since the formed cavities stay and occupy a certain volume inside the microchannel, the flow through the microchannel can be blocked and plugging issues can occur when processing certain solid dispersions or materials with high aspect ratios. Third, the place with the most severe cavitation is typically at the microchannel entrance due to the reduced available cross-sectional area near a typical microchannel entrance, which limits the flow rate through the microchannel and subsequently results in a lower average flow velocity at the channel exit. This can reduce the energy of the fluid at the microchannel exit and lead to the reduction of process efficiency for certain applications.

In addition to the disadvantages associated with cavitation, a design limitation of typical multi-slotted high-shear mixing chambers is that a typical multi-slotted high-shear mixing chamber can only include a limited number of individual microchannels based on the physical dimensions of the machine with the multi-slotted high-shear mixing chamber. Additionally, space is required between each individual microchannel which further limits the number of individual microchannels that the typical multi-slotted high-shear mixing chamber may include. These physical constraints limit a throughput of the typical multi-slotted high-shear mixing chamber.

Accordingly, a high-shear mixing chamber is desired that improves upon the above drawbacks.

### SUMMARY

The present disclosure relates generally to a high-shear mixing chamber for a fluid processor or fluid homogenizer. More specifically, a high-shear mixing chamber is provided having a single wide slot microchannel that enables a higher throughput, less plugging, and a longer life (e.g., less wear) than typical multi-slotted high-shear mixing chambers. The cross-sectional area at the entrance of the wide slot microchannel is greater than the cross-sectional area at each individual microchannel entrance of a typical multi-slotted high-shear mixing chamber, which can help reduce the occurrence of plugging issues and help increase a maintenance life of the provided high-shear mixing chamber. For instance, the greater cross-sectional area at the wide slot microchannel entrance may help reduce the severity of cavitation at the wide slot microchannel entrance. The wide slot microchannel additionally eliminates the empty space between individual microchannels of a typical multi-slotted high-shear mixing chamber. As such, the provided high-shear mixing chamber can have a higher throughput than at least some typical multi-slotted high-shear mixing chambers.

In some aspects, the wide slot microchannel may have a stepped interior such that the wide slot microchannel has portions with different depths. The corners created by the stepped interior can help increase shear generation as fluid flows through the wide slot microchannel.

In an example, a high-shear mixing chamber for a fluid processor includes an inlet chamber including an inlet hole and a bottom end, an inlet plenum in fluid communication with the bottom end of the inlet chamber, an outlet chamber including an outlet hole and a top end, an outlet plenum in fluid communication with the top end of the outlet chamber, and a microchannel connecting the inlet plenum to the outlet plenum. A first portion of the microchannel has a first uniform depth, a second portion of the microchannel has a second uniform depth, and a third portion of the microchannel has a third uniform depth. The first depth is different than the second depth. The first, second and third portions run parallel along a length of the microchannel from the inlet plenum to outlet plenum.

In another example, a high-shear mixing chamber for a fluid processor includes a vertically-disposed inlet chamber including an inlet hole and a bottom end, an inlet plenum in fluid communication with the bottom end of the inlet chamber, a vertically-disposed outlet chamber including an outlet hole and a top end, an outlet plenum in fluid communication with the top end of the outlet chamber, and a microchannel connecting the inlet plenum to the outlet plenum. The microchannel extends a length from the inlet plenum to the outlet plenum. A width of the microchannel is greater than a width of the inlet chamber and a width of the outlet chamber.

### BRIEF DESCRIPTION OF THE DRAWINGS

FIGS. 1 and 2 illustrate a typical multi-slotted high-shear mixing chamber, according to an aspect of the present disclosure.

FIG. 3 illustrates velocity profiles for the high-shear mixing chamber of FIGS. 1 and 2, according to an aspect of the present disclosure.

FIG. 4 illustrates a high-shear mixing chamber having a wide slot microchannel, according to an aspect of the present disclosure.

FIG. 5 illustrates a cross section of the high-shear mixing chamber of FIG. 4, according to an aspect of the present disclosure.

FIG. 6 illustrates a high-shear mixing chamber having a stepped wide slot microchannel, according to an aspect of the present disclosure.

FIG. 7 illustrates a cross-sectional view of the stepped wide slot microchannel of FIG. 6, according to an aspect of the present disclosure.

FIG. 8 illustrates a cross-sectional view of the high-shear mixing chamber of FIG. 6, according to an aspect of the present disclosure.

FIGS. 9A to 9E illustrate cross-sectional views of stepped wide slot microchannels, according to aspects of the present disclosure.

FIG. 10 illustrates a high-shear mixing chamber having multiple microchannels with a stepped interior, according to an aspect of the present disclosure.

FIG. 11 illustrates a cross section of a high-shear mixing chamber having a wide slot microchannel and inlet and outlet chambers that extend beyond the microchannel, according to an aspect of the present disclosure.

FIG. 12 illustrates a schematic depiction of an exemplary system for processing of a liquid/reactant stream, according to an aspect of the present disclosure.

FIG. 13 illustrates a schematic depiction of a further exemplary system for processing of a liquid/reactant stream, according to an aspect of the present disclosure.

### DETAILED DESCRIPTION

The present disclosure provides a new and innovative high-shear mixing chamber having a single wide slot microchannel that enables a higher throughput, less plugging, and a longer life (e.g., less wear) than typical multi-slotted high-shear mixing chambers. The provided high-shear mixing chamber may include an inlet in fluid communication with an inlet plenum, an outlet in fluid communication with an outlet plenum, and the single wide slot microchannel connecting the inlet plenum to the outlet plenum.

Rather than multiple individual microchannels, as in a typical multi-slotted high-shear mixing chamber, in some examples, the provided high-shear mixing chamber includes a single wide slot microchannel. For example, each microchannel in a typical multi-slotted high-shear mixing chamber may have an aspect ratio (width:depth) of about 1:1, 2:1, or 4:1. In contrast, the single wide slot microchannel of the provided high-shear mixing chamber may have an aspect ratio (width:depth) of greater than or equal to 10:1, such as, for example, 20:1, 50:1, or 100:1. As such, the cross-sectional area at the entrance of the wide slot microchannel is greater than the cross-sectional area at each individual microchannel entrance of a typical multi-slotted high-shear mixing chamber, which can help reduce the occurrence of plugging issues and help increase a maintenance life of the provided high-shear mixing chamber. For instance, the greater cross-sectional area at the wide slot microchannel entrance may help reduce the severity of cavitation at the wide slot microchannel entrance. Reduced cavitation severity can help reduce the amount of damage, or wear, done to the high-shear mixing chamber and can help reduce cavity formation that obstructs flow during operation.

The wide slot microchannel additionally eliminates the empty space between individual microchannels of a typical multi-slotted high-shear mixing chamber. As such, the provided high-shear mixing chamber can have a higher throughput than at least some typical multi-slotted high-shear mixing chambers. For instance, more fluid can flow through the wide slot microchannel as compared to individual microchannels occupying the same amount of space since the wide slot microchannel eliminates the empty space between the individual microchannels.

Typical multi-slotted high-shear mixing chambers do not have a microchannel with as great of an aspect ratio (width:depth) as the wide slot microchannel of the provided high-shear mixing chamber mainly for two reasons. First, a higher aspect ratio means a higher cross-sectional area and therefore a higher flow rate/throughput, which can exceed a machine's capacity if the flow rate is too high and result in the chamber being unable to reach a high enough pressure (e.g., 30 kpsi). Second, the increased cross-sectional area and reduction in pressure results in a lower shear rate than desired. The inventors, however, have found that a wide slot microchannel reduces the occurrence of plugging issues and provides the throughput advantages as described above while still generating a suitable amount of shear as compared to typical multi-slotted high-shear mixing chambers.

In some aspects, the wide slot microchannel of the provided high-shear mixing chamber may have a stepped interior such that the wide slot microchannel has portions with different depths. In such aspects, the wide slot microchannel may have one, two, three, or any suitable quantity of steps. The wide slot microchannel has a first surface (e.g., a top surface) opposite a second surface (e.g., a bottom surface) and steps may be formed with the first surface alone, the second surface alone, or with both the first surface and the second surface. The steps may extend a full length of the microchannel between the inlet plenum and the outlet plenum. Steps formed with the first surface may extend towards or away from the second surface, and vice versa. The corners created by the stepped interior can help increase shear generation as fluid flows through the wide slot microchannel.

It will be appreciated that, instead of a single wide slot microchannel, the provided high-shear mixing chamber may include a small number of wide slot microchannels, e.g., 2, 3, 4, 5, etc. that are each wider than typical microchannels of a high-shear mixing chamber. For instance, an aspect in which the provided high-shear mixing chamber includes two wide slot microchannels each with an aspect ratio (width:depth) of 20:1 still eliminates empty space between individual microchannels of at least some typical multi-slotted high-shear mixing chambers (i.e. there is only one gap, or empty space, between the two wide slot microchannels). The two wide slot microchannels additionally each still have a greater cross-sectional area at their entrances than the cross-sectional area at each individual microchannel entrance of a typical multi-slotted high-shear mixing chamber. In such aspects of the provided high-shear mixing chamber having a small number of wide slot microchannels, each wide slot microchannel may have a stepped interior.

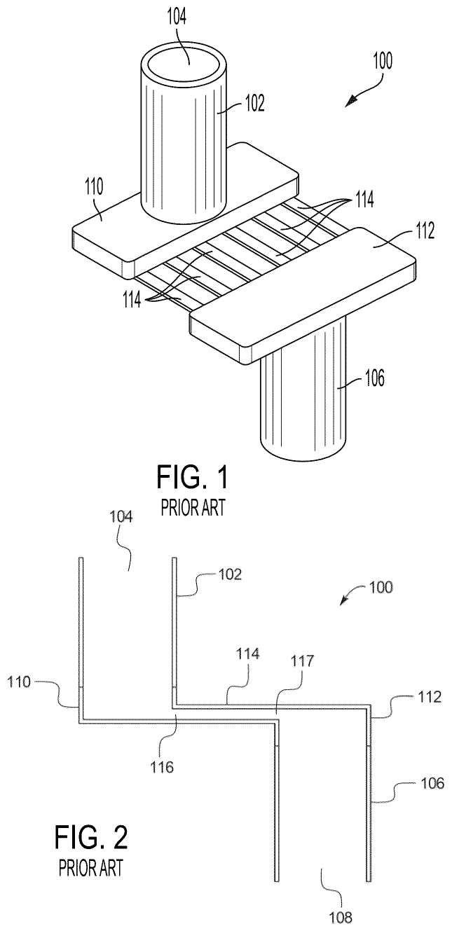

FIGS. 1 and 2 show an example of the working section of a typical multi-slotted high-shear mixing chamber 100. The high-shear mixing chamber 100 includes an inlet chamber 102 with an inlet hole 104, an outlet chamber 106 with an outlet hole 108, an inlet plenum 110 and an outlet plenum 112, and a plurality of microchannels 114 (e.g., between two and twenty microchannels) connecting the inlet plenum 110 to the outlet plenum 112. In at least some aspects, the inlet chamber 102 and the outlet chamber 106 may be cylinders. Each microchannel 114 includes a microchannel entrance 116 where the microchannel 114 meets the inlet plenum 110 and a microchannel exit 117 where the microchannel 114 meets the outlet plenum 112. In various examples, each microchannel 114 may have a width within a range of 0.006 inches to 0.04 inches and a depth within a range of 0.002 inches to 0.03 inches.

In use, incoming fluid at very high pressure enters the inlet hole 104, passes through the inlet chamber 102 and the inlet plenum 110, and then enters the plurality of microchannels 114 at the microchannel entrances 116. The fluid then exits the plurality of microchannels 114 out of the microchannel exits 117 and into the outlet plenum 112, passes through the outlet chamber 106, and exits through the outlet hole 108. The high incoming fluid pressure imparts high shear on the fluid as it passes through the working section of the typical multi-slotted high-shear mixing chamber 100.

Cavitation often occurs in two places inside the high-shear mixing chamber 100: (i) the area of the microchannel entrances 116; and (ii) the outlet hole 108. The transition of the fluid flow into the microchannels 114 with a sharp turn at the microchannel entrances 116 usually leads to cavitation. Further, the most severe cavitation may occur near the microchannel entrances 116 due to the reduced available cross-sectional area near each of the microchannel entrances 116. Cavitation can cause damage to the internal surface of the microchannels 114 thereby wearing down the microchannels 114, which can reduce the performance and life of the high-shear mixing chamber 100.

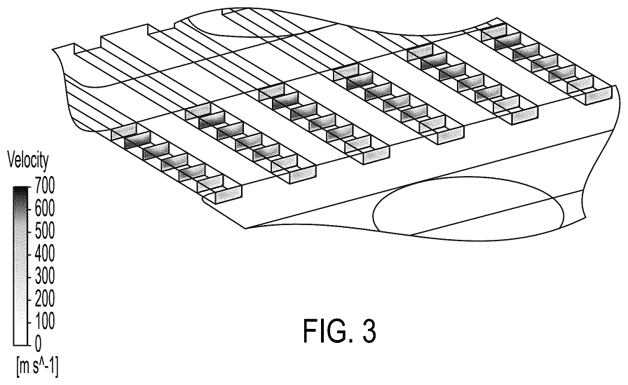

Additionally, the reduced available cross-sectional area near the microchannel entrances 116 limits the flow rate through the microchannels 114 and subsequently results in a lower average flow velocity at the microchannel exits 117. This can reduce the energy of the fluid at the microchannel exits 117 and lead to the reduction of process efficiency for certain applications. FIG. 3 show the velocity profiles of the high-shear mixing chamber 100 using a computational fluid dynamics simulation. As shown in FIG. 3, the velocity profiles for the high-shear mixing chamber 100 are not uniformly distributed from microchannel to microchannel. Stated differently, the velocity profiles at the same position of each microchannel are not the same. The non-uniform velocity distribution is in part due to the entrance effect and the small cavitation pocket, which causes a higher flow velocity near the bottom half of each microchannel. Another reason for the non-uniform velocity distribution is the flow distribution inside the inlet plenum 110—the microchannels towards the center of the inlet plenum 110 get a higher flow velocity since they are closer to the inlet chamber 102. Flow has to travel longer to reach the microchannel towards the ends of the inlet plenum 110. A consequence of the non-uniform velocity distribution may be variations of the processed materials between microchannels 114 as well as the plugging of certain materials.

Additionally, a design limitation of the typical high-shear mixing chamber 100 is that only a limited number of microchannels 114 can fit in a single machine based on the physical dimensions of the machine. As such, a throughput of a machine with a typical high-shear mixing chamber 100 is correlated with a quantity of microchannels 114 in the high-shear mixing chamber 100, which is further limited by the empty space required between individual microchannels 114. As used herein, a throughput is an amount of fluid that may pass through the high-shear mixing chamber 100 at a given time.

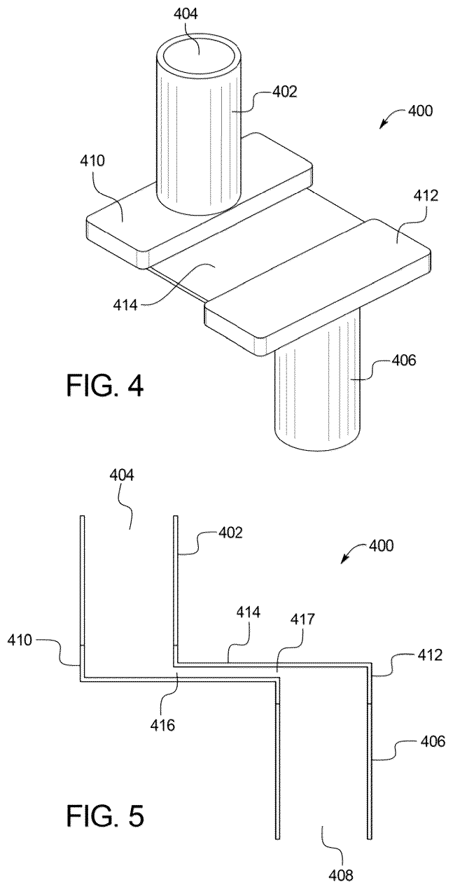

FIGS. 4 and 5 show an example of the working section of the presently disclosed high-shear mixing chamber 400. In some various aspects, the high-shear mixing chamber 400 may include an inlet chamber 402 with an inlet hole 404, an outlet chamber 406 with an outlet hole 408, and a single wide slot microchannel 414 connecting the inlet chamber 402 to the outlet chamber 406. In some aspects, the high-shear mixing chamber 400 may include an inlet plenum 410 and/or an outlet plenum 412. In such aspects, the single wide slot microchannel 414 may connect the inlet plenum 410 to the outlet plenum 412. The remaining description will be of the aspects in which the high-shear mixing chamber 400 include the inlet plenum 410 and the outlet plenum 412. In at least some aspects, the inlet chamber 402 and the outlet chamber 406 may be cylinders. The wide slot microchannel 414 includes a microchannel entrance 416 where the wide slot microchannel 414 meets the inlet plenum 410 and a microchannel exit 417 where the wide slot microchannel 414 meets the outlet plenum 412. In use, incoming fluid enters the inlet hole 404, passes through the inlet chamber 402 and the inlet plenum 410, and then enters the wide slot microchannel 414 at the microchannel entrance 416. The fluid then exits the wide slot microchannel 414 out of the microchannel exit 417 and into the outlet plenum 412, passes through the outlet chamber 406, and exits through the outlet hole 408.

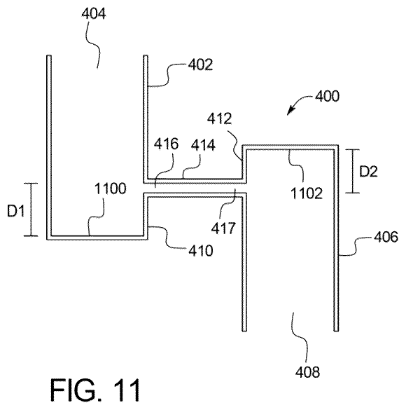

Although FIG. 5 illustrates the respective ends of the inlet plenum 410 and the outlet plenum 412 as flush with the wide slot microchannel 414, in other examples, at least one of the respective ends of the inlet plenum 410 and the outlet plenum 412 may extend beyond the wide slot microchannel 414. For example, FIG. 11 illustrates both the respective ends 1100 and 1102 of the inlet plenum 410 and the outlet plenum 412 extending beyond the wide slot microchannel 414. As illustrated, the wide slot microchannel 414 is located a distance DI from end 1100 of the inlet plenum 410 and a distance D2 from end 1102 of the outlet plenum 412. D1 and D2 can be the same or different distances. In an example, D1 and D2 can be in the range of 0.001 to 1 inch. In another example, D1 and D2 can be in the range of 0.01 to 0.03 inches. It has been determined that adding the distances D1 and D2 between a microchannel (e.g., the wide slot microchannel 414) and an end 1100 and/or end 1102 of the high-shear mixing chamber 400 streamlines the flow when it enters the wide slot microchannel 414 and reduces the level of cavitation at the microchannel entrance 416 and the microchannel exit 417. That is, disposing the wide slot microchannel 414 above the end 1100 creates a pool of fluid at the end 1102, which deters cavitation. In aspects in which the high-shear mixing chamber 400 does not include an inlet plenum 410 and outlet plenum 412, the wide slot microchannel 414 may be located a distance D1 or D2 from respective ends of at least one of the inlet chamber 402 and the outlet chamber 406.

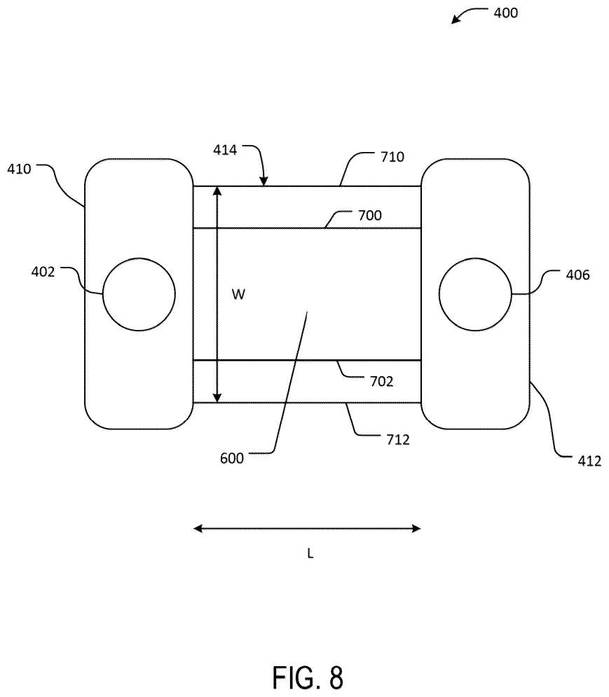

The wide slot microchannel 414 extends a length L (FIG. 8) from the inlet plenum 410 to the outlet plenum 412 and has a width W (FIGS. 7 and 8) perpendicular to its length L. An interior of the wide slot microchannel 414 has a depth extending from a first surface (e.g., a top surface nearest the inlet chamber 402) to a second surface (e.g., a bottom surface nearest the outlet chamber 406). The depth of the wide slot microchannel 414 is perpendicular to both the length L and the width W of the wide slot microchannel 414. In various examples, the width W of the wide slot microchannel 414 may be between 0.01 inches and 1 inch. In some examples, the width W of the wide slot microchannel 414 may be between 0.1 inches and 1 inch. In various examples, the length L of the wide slot microchannel 414 may be between 0.01 inches and 1 inch. In some examples, the length L of the wide slot microchannel 414 may be between 0.1 inches and 1 inch.

In at least some aspects, a width W of the wide slot microchannel 414 is greater than a width or diameter of the inlet chamber 402 and/or a width or diameter of the outlet chamber 406. In various aspects, the width W of the wide slot microchannel 414 is greater than or equal to ½, ⅗, ⅔, 7/10, ¾, ⅘, 9/10, or another suitable proportion, of a width of the inlet plenum 410 and/or the outlet plenum 412. In one example, the width W of the wide slot microchannel 414 may be substantially equal to, or slightly less than, the width of the inlet plenum 410 and/or the outlet plenum 412. In some aspects, the width W of the wide slot microchannel 414 may be greater than the length L of the wide slot microchannel 414. In one aspect, the depth of the wide slot microchannel 414 may be uniform along the length L and the width W of the wide slot microchannel 414. In various examples, the depth of the wide slot microchannel 414 may be within a range of 0.002 inches and 0.1 inches. In some examples, the depth of the wide slot microchannel 414 may be within a range of 0.002 inches and 0.03 inches.

In various aspects, the wide slot microchannel 414 may have an aspect ratio (width:depth) of greater than or equal to 10:1, such as, for example, 20:1, 50:1, 100:1, 200:1. In some aspects, the wide slot microchannel 414 may have an aspect ratio (width:depth) of less than or equal to 200:1, 300:1, 400:1, or 500:1. In some aspects, the wide slot microchannel 414 may have an aspect ratio (width:depth) within a range of 10:1 and 500:1. In some aspects, the wide slot microchannel 414 may have an aspect ratio (width:depth) within a range of 10:1 and 350:1. In some aspects, the wide slot microchannel 414 may have an aspect ratio (width:depth) within a range of 10:1 and 200:1. In some aspects, the wide slot microchannel 414 may have an aspect ratio (width:depth) within a range of 20:1 and 500:1. In some aspects, the wide slot microchannel 414 may have an aspect ratio (width:depth) within a range of 50:1 and 500:1. In some aspects, the wide slot microchannel 414 may have an aspect ratio (width:depth) within a range of 100:1 and 500:1. Any of the various ranges disclosed herein for the various features of the high-shear mixing chamber 400 is inclusive of the ends of the range.

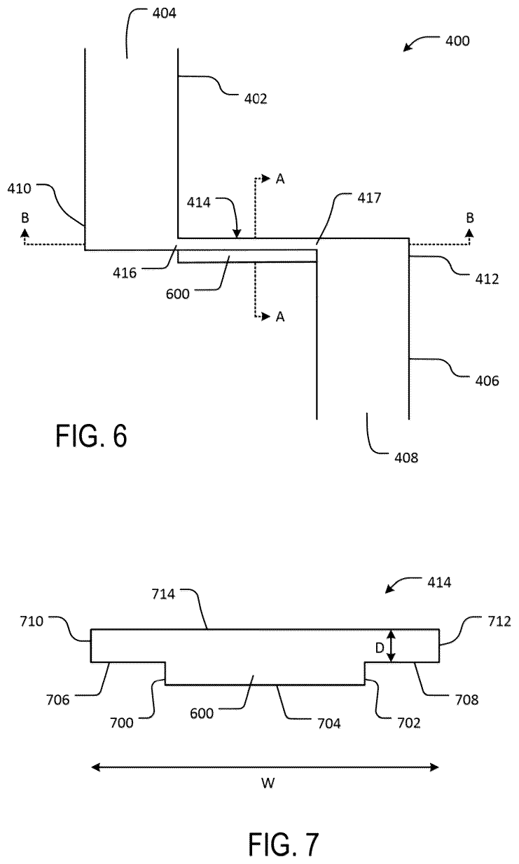

In some aspects of the present disclosure, the wide slot microchannel 414 may have a stepped interior. For example, FIG. 6 illustrates the high-shear mixing chamber 400 including an example wide slot microchannel 414 having a step 600. FIG. 7 illustrates a cross-sectional view of the example wide slot microchannel 414 at the plane A-A shown in FIG. 6. In the example of FIG. 7, the wide slot microchannel 414 includes a first surface 714 opposite a second surface including the surfaces 704, 706, and 708. The surface 706 is joined to the first surface 714 by a wall 710 and the surface 708 is joined to the first surface 714 by a wall 712. The first surface 714 may be a top surface. The second surface may be a bottom surface. The surface 704 is offset from the surfaces 706 and 708 by the walls 700 and 702 thereby forming the step 600.

In this example, the step 600 extends away from the first surface 714 thereby increasing a depth of a central portion of the wide slot microchannel 414. For instance, the wide slot microchannel 414 may have a depth D in a first portion between the first surface 714 and the surface 708, a depth greater than D in a second portion between the first surface 714 and the surface 704, and a depth D in a third portion between the first surface 714 and the surface 706. In other examples, the third portion between the first surface 714 and the surface 706 may have a depth different than the first and second portions. In various aspects, the depth of the second portion may be within a range of greater than the depth D and less than or equal to a depth 3D. Stated differently, in such aspects, a ratio of the depth of the second portion to the depth of the first and/or third portion is less than or equal to 3:1. In some examples, the ratio of the depth of the second portion to the depth of the first and/or third portion may less than or equal to 2:1.

In some aspects, a depth of the walls 710 and 712 (in this example, the depth D) may be equal to a depth of the walls 700 and 702. In other aspects, the depth of the walls 710 and 712 may be greater than or less than the depth of the wall 700 and 702. As illustrated in FIG. 7, the depth of the first, second, and third portions of the wide slot microchannel 414 may be uniform. In other aspects, a depth of one or more of the first, second, and third portions may be non-uniform. For example, in such other aspects, rather than the surface 704 being parallel with the first surface 714 as shown in FIG. 7, the surface 704 and/or the first surface 714 may be slanted such that the surface 704 and the first surface 714 are non-parallel with one another.

In at least some instances, the corners formed by the stepped interior helps increase shear generation as fluid flows through the wide slot microchannel 414. Stated differently, shear may be highest at the edges, or corners, of the wide slot microchannel 414 and the stepped interior creates additional corners compared to a wide slot microchannel 414 having a constant depth interior. For instance, additional corners are generated at the intersections of (1) the surface 706 and the wall 700, (2) the wall 700 and the surface 704, (3) the surface 704 and the wall 702, and (4) the wall 702 and the surface 708. In this example, each of these additional corners is a right angle. In other examples, such as the non-uniform depth aspects described above, at least some of the corners formed by the stepped interior may be non-right angles (e.g., 70°, 80°, 85°, etc.)

As shown in FIG. 7, the wide slot microchannel 414 has a width W. In some aspects, the cross-section of the wide slot microchannel 414 may be symmetrical about an axis in the center of the width W of the wide slot microchannel 414. For instance, in some examples, the first portion, the second portion, and the third portion may have equal widths. In other examples, such as the illustrated one, the first and third portions may have an equal width while the second portion has a greater or smaller width than the first and third portions. In other aspects, the cross-section of the wide slot microchannel 414 may be asymmetrical about the axis in the center of the width W of the wide slot microchannel 414. For instance, in some examples, the first portion and the third portion may have unequal widths. In such examples, the second portion may have a width equal to the first portion or the third portion. In other examples, the first portion, the second portion, and the third portion may all have different widths.

FIG. 8 illustrates a cross-sectional view of the example wide slot microchannel 414 at the plane B-B shown in FIG. 6. In FIG. 8, the first portion of the wide slot microchannel 414, described above with respect to FIG. 7, is the section between the wall 702 and the wall 712. The second portion of the wide slot microchannel 414 is the section between the wall 700 and the wall 702, and the third portion of the wide slot microchannel 414 is the section between the wall 710 and the wall 700. In the example of FIG. 8, each of the first portion, second portion, and third portion extends the length L of the wide slot microchannel 414 from the inlet plenum 410 to the outlet plenum 412. Stated differently, a depth of the first portion is uniform from the inlet plenum 410 to the outlet plenum 412, and likewise for the second and third portions. In other examples, a respective depth of the first, second, and third portions might not be uniform from the inlet plenum 410 to the outlet plenum 412. For instance, a section of the wide slot microchannel 414 may have a uniform depth along a width of the wide slot microchannel 414 and another section may be broken into the first, second, and third portions having differing depths.

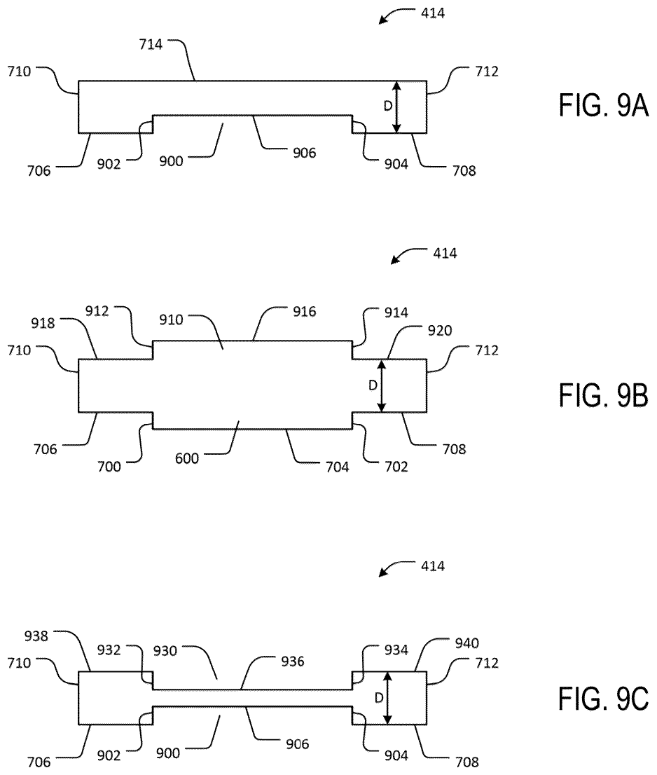

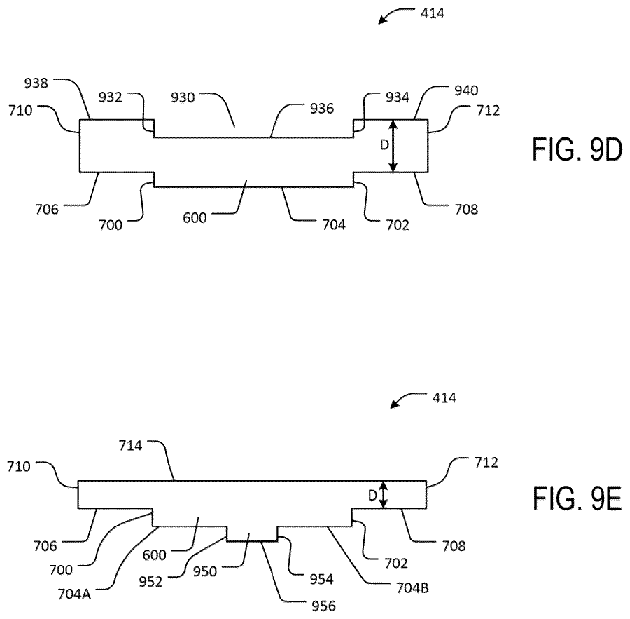

FIGS. 9A to 9E illustrate cross-sectional views of various examples of the wide slot microchannel 414. In the example of FIG. 9A, rather than a step 600 that extends away from the first surface 714, the wide slot microchannel 414 includes a step 900 that extends towards the first surface 714. The second surface includes the surfaces 706, 708, and 906. The surface 906 is offset from the surfaces 706 and 708 by the walls 902 and 904 thereby forming the step 900. The step 900 extending towards the first surface 714 thereby decreases a depth of a central portion of the wide slot microchannel 414. For example, the wide slot microchannel 414 may have a depth D in a first portion between the first surface 714 and the surface 708, a depth less than D in a second portion between the first surface 714 and the surface 906, and a depth D in a third portion between the first surface 714 and the surface 706.

In the example of FIG. 9B, the wide slot microchannel 414 may have a second surface including a step 600 as described above. The second surface may be opposite a first surface including the surfaces 916, 918, and 920. The surface 916 is offset from the surfaces 918 and 920 by the walls 912 and 914 thereby forming the step 910. As shown, the step 910 extends away from the second surface. The step 600 extending away from the first surface and the step 910 extending away from the second surface thereby increases a depth of a central portion of the wide slot microchannel 414. For example, the wide slot microchannel 414 may have a depth D in a first portion between the surface 920 and the surface 708, a depth greater than D in a second portion between the surface 916 and the surface 704, and a depth D in a third portion between the surface 918 and the surface 706. In some aspects, the step 600 and the step 910 may have equal depths. Stated differently, a depth of the walls 700 and 702 may be equal to a depth of the walls 912 and 914. In other aspects, the step 600 and the step 910 may have unequal depths such that the step 600 has a depth greater or less than a depth of the step 910.

In the example of FIG. 9C, the wide slot microchannel 414 may have a second surface including a step 900 as described above. The second surface may be opposite a first surface including the surfaces 936, 938, and 940. The surface 936 is offset from the surfaces 938 and 940 by the walls 932 and 934 thereby forming the step 930. As shown, the step 930 extends towards the second surface. The step 900 extending towards the first surface and the step 930 extending towards the second surface thereby decreases a depth of a central portion of the wide slot microchannel 414. For example, the wide slot microchannel 414 may have a depth D in a first portion between the surface 940 and the surface 708, a depth less than D in a second portion between the surface 906 and the surface 936, and a depth D in a third portion between the surface 938 and the surface 706. In some aspects, the step 900 and the step 930 may have equal depths. Stated differently, a depth of the walls 902 and 904 may be equal to a depth of the walls 932 and 934. In other aspects, the step 900 and the step 930 may have unequal depths such that the step 900 has a depth greater or less than a depth of the step 930.

In the example of FIG. 9D, the wide slot microchannel 414 may have a first surface including a step 930 as described above and a second surface including a step 600 as described above. As shown, the step 930 extends towards the second surface and the step 600 extends away from the first surface. In some aspects, a depth of the step 930 may be equal to a depth of step 600. Stated differently, a depth of the walls 932 and 934 may be equal to a depth of the walls 700 and 702. In such aspects, the wide slot microchannel 414 may have an equal, though offset, depth along a width of the wide slot microchannel 414. For example, the wide slot microchannel may have a depth D in a first region between the surface 940 and the surface 708, a depth D in a second portion between the surface 936 and the surface 704, and a depth D in a third portion between the surface 938 and the surface 706. In other aspects, the step 930 and the step 600 may have unequal depths. In such other aspects, the second portion between the surface 936 and the surface 704 may have a depth greater than or less than a depth D.

It should be appreciated that, in any of the example shown in FIGS. 9A to 9D, the first surface and the second surface may be switched. For example, in the example of FIG. 9D, the first surface may include a step (e.g., the step 910) that extends away from the second surface and the second surface may include a step (e.g., the step 900) that extends towards the first surface. As described in connection with FIG. 7 above, the respective depths and widths of the first, second, and third portions in the examples shown in FIGS. 9A to 9D may have any suitable aspect ratio.

Each of the examples described in connection with FIGS. 9A to 9D have a first and/or second surface with a single step. In other examples, the wide slot microchannel 414 may have a first and/or second surface with more than one step. For example, FIG. 9E illustrates a cross-sectional view of the wide slot microchannel 414 having a second surface with two steps. In this example, the wide slot microchannel 414 may have a second surface including the surfaces 704A and 704B that are offset from the surfaces 706 and 708 by the walls 700 and 702, thereby forming a step 600, and a surface 956 offset from the surfaces 704A and 704B by the walls 952 954 thereby forming a step 950. The step 950 extends from the step 600 and away from the first surface 714.

The step 950 extending away from the first surface 714 thereby increases a depth of a central portion of the wide slot microchannel 414 relative to other portions of the wide slot microchannel 414. For example, the wide slot microchannel 414 may have a depth D in a first portion between the surface 14 and the surface 708, a depth greater than D in a second portion between the surface 714 and the surface 704B, a depth greater than the second portion in a third portion between the surface 714 and the surface 956, a depth greater than D in a fourth portion between the surface 714 and the surface 704A, and a depth D in a fifth portion between the surface 714 and the surface 706. In some aspects, the step 950 and the step 600 may have equal depths. Stated differently, a depth of the walls 952 and 954 may be equal to a depth of the walls 700 and 702. In other aspects, the step 950 and the step 600 may have unequal depths such that the step 950 has a depth greater or less than a depth of the step 600.

As with the examples of FIGS. 7 and 9A to 9D, the respective depths and widths of the first, second, third, fourth, and fifth portions of the example of FIG. 9E may have any suitable aspect ratio. In one specific example, a depth of the third portion may be 1.5D, or 1.5 times a depth of the first portion, and a depth of the second portion may be 1.2D, or 1.2 times a depth of the first portion. In another specific example, a width of the third portion may be twice a width of the second portion and twice a width of the first portion. A width of the fourth portion may be equal to the width of the second portion, and a width of the fifth portion may be equal to the width of the first portion, in this specific example.

In various aspects, a wide slot microchannel 414 having two or more steps may have any of the orientations described in connection with the wide slot microchannel 414 having a single step. For example, the first surface 714 may include the steps 600 and 950 rather than the second surface, or the first surface 714 and the second surface may each include two or more steps that extend towards or away from the opposing surface. In some aspects, a surface having two or more steps may include steps that extend in opposing directions. For example, the step 950 may instead extend towards the surface 714 while the step 600 extends away from the surface 714. In some aspects, the first surface and the second surface may have an equal quantity of steps. In other aspects, the first surface and the second surface may have an unequal quantity of steps.

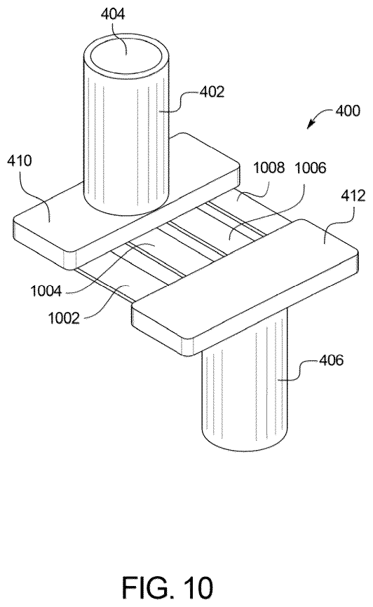

In another example embodiment shown in FIG. 10, the high-shear mixing chamber 400 may include multiple microchannels 1002, 1004, 1006, 1008 that each have a stepped interior. For instance, each microchannel 1002, 1004, 1006, and 1008 may have one of the stepped interiors described above in such examples. In some aspects, each microchannel 1002, 1004, 1006, and 1008 may have the same type of stepped interior (e.g., each as the stepped interior of FIG. 9A). In other aspects, at least one microchannel 1002, 1004, 1006, 1008 may have a different type of stepped interior than the others. For example, the microchannels 1002 and 1006 may have the stepped interior of FIG. 9A whereas the microchannels 1004 and 1008 may have the stepped interior of FIG. 9B. In examples in which the high-shear mixing chamber 400 includes multiple microchannels, each microchannel may have an aspect ratio (width:depth) of greater than or equal to 4:1, such as, for example, 10:1, 20:1, 50:1, 100:1, 150:1, or 200:1. In some aspects, each microchannel may have an aspect ratio (width:depth) of greater than or equal to 10:1. In some aspects, each microchannel may have an aspect ratio (width:depth) of less than or equal to 100:1, 150:1, 200:1, or 250:1. Additionally, while FIG. 10 illustrates the high-shear mixing chamber 400 including four microchannels having a stepped interior, in other examples, the high-shear mixing chamber 400 may have another suitable number of stepped interior microchannels (e.g., two, three, five, etc.)

In some aspects, the high-shear mixing chamber 400 may be at least partially constructed of a suitable ceramic (e.g., alumina) and/or diamond (e.g., polycrystalline diamond). In one example, the high share mixing chamber 400 may be entirely constructed of polycrystalline diamond. In some aspects, at least a portion of the interior of the high-shear mixing chamber 400 may be coated with diamond (e.g., polycrystalline diamond). For example, the entirety of the interior of the high-shear mixing chamber 400 may be coated with diamond. In some instances, the high-shear mixing chamber 400 may be coated via vapor deposition.

In various aspects, the high-shear mixing chamber 400 may be constructed to withstand operating pressures of greater than or equal to 5,000 psi, 10,000 psi, 20,000 psi, or 35,000 psi without failure. For example, the high-shear mixing chamber 400 may be constructed to withstand an operating pressure between 5,000-50,000 psi, between 10,000-40,000 psi, between 10,000-50,000 psi, between 5,000-40,000 psi, between 5,000-30,000 psi, between 10,000-30,000 psi, between 5,000-25,000 psi, between 10,000-25,000 psi, between 5,000-20,000 psi, between 10,000-20,000 psi, between 30,000-50,000 psi, between 20,000-40,000 psi, between 20,000-50,000 psi, between 15,000-40,000 psi, between 15,000-50,000 psi, and other suitable pressure ranges.

In various examples, the high-shear mixing chamber 400 and/or one or more of the microchannels disclosed herein (e.g., the wide slot microchannel 414 or the microchannels 1002, 1004, 1006, 1008) may be a component of any suitable high-pressure fluid system, such as high-pressure fluid mixers, high-pressure/high sheer fluid processors, high-pressure impinger jet reactors and high-pressure homogenizers. These suitable high-pressure fluid systems may include various systems from Microfluidics International Corporation, a unit of IDEX Corporation located in Westwood, MA, such as pilot scale machines and production scale machines. For example, the pilot scale machines may include the Pilot Scale M110EH and the Pilot Scale M815 product offerings from Microfluidics International Corporation. The production scale machines may include the M700 and M710 Series product offerings (e.g., M7125 and M7250) from Microfluidics International Corporation.

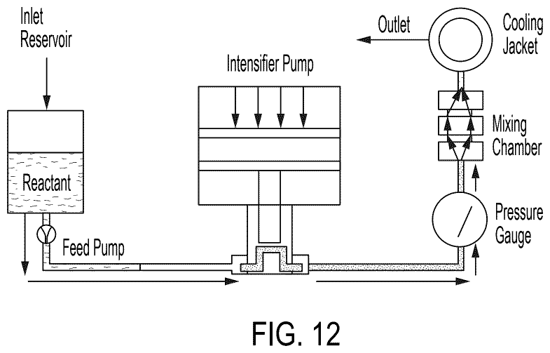

Exemplary apparatus/systems according to the present disclosure are generally designed to accommodate the mixing of a liquid stream, e.g., reactant. The liquid stream is generally pumped to an intensifier pump by a feed pump. The disclosed apparatus/systems are designed such that the liquid stream is mixed in a controlled ratio, in a controlled location, and with controlled energy input. For example, FIG. 12 illustrates an example liquid stream (“Reactant”) schematically depicted as part of a processing arrangement according to the present disclosure. The liquid stream may take various forms and exhibit various properties according to the present disclosure, e.g., it may be a multiphase fluid, miscible fluid and/or immiscible fluid. The liquid stream is depicted in connection with a feed vessel/inlet reservoir. Of course, the manner in which the liquid stream is processed and/or stored prior to introduction to the disclosed processing apparatus/system may vary widely, with the disclosed inlet reservoir being merely illustrative of pre-processing handling/storage of reactant/fluid streams. The liquid stream is generally combined in connection with an intensifier pump or other high pressure pump, so as to pressurize such liquid stream (e.g., to pressures up to 50,000 psi) for feed to a mixing chamber (e.g., the high-shear mixing chamber 400).

The feed pump in combination with the intensifier/high pressure pump control the flow rate of the liquid stream. The energy input to the liquid stream at different locations of the system is controlled by the geometry of the flow path. Thus, energy dissipation may be controlled/minimized through advantageous piping design/layout, the design/geometry of the mixing chamber/microreactor, and the design/layout of heat exchanger positioned downstream of the mixing chamber. Typically, energy dissipation is most strongly influenced by the design/geometry of the mixing chamber/microreactor, e.g., through turbulence and/or shear associated therewith.

The liquid stream advantageously mixes inside the fixed geometry mixing chamber/microreactor at the nanometer scale. Downstream of the mixing chamber/microreactor, the liquid stream is typically fed into a heat exchanger where it is cooled or heated (if desired). In some instances, the liquid stream may be collected, in whole or in part, at this processing stage. However, in exemplary embodiments/implementations of the present disclosure, the liquid stream may be recycled to the apparatus/system, in whole or in part, e.g., through introduction of a recycle feed upstream of the intensifier pump/high pressure pump.

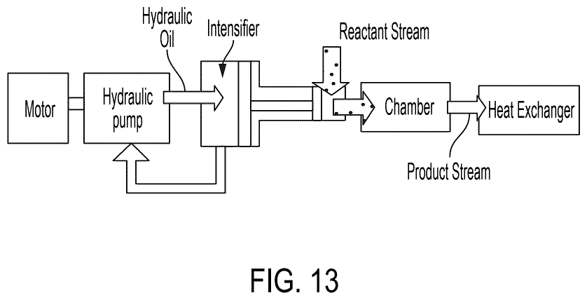

FIG. 13 illustrates a schematic depiction of an exemplary flow implementation according to the present disclosure. A hydraulic pump is powered by a motor so as to deliver hydraulic oil to an intensifier pump. A liquid feed stream (“Reactant Stream”) is introduced to the intensifier pump and the liquid stream is pressurized for delivery to a mixing chamber (e.g., the high-shear mixing chamber 400). Upon exiting the mixing chamber, the liquid product stream may enter a heat exchanger for temperature control (i.e., cooling or heating).

While FIGS. 12 and 13 illustrate a single reactant liquid stream, in some examples, two or more reactant liquid streams may be generally combined in connection with an intensifier pump or other high pressure pump, so as to pressurize such combined liquid stream (e.g., to pressures up to 50,000 psi) for feed to the mixing chamber. In such examples, the two or more reactant liquid streams may be combined in a manifold, tee or the like prior to introduction through a port into the intensifier pump, or may be introduced into the intensifier pump through separate ports. Alternatively, the exemplary apparatus/systems may include a coaxial feed feature/design for delivery of the two or more liquid streams to the intensifier pump. In one particular example, the feed line/pipe for a first liquid stream may be positioned within the feed line/pipe for a second liquid stream such that delivery of such reactant liquid streams to the intensifier pump (or other high pressure pump) is substantially coaxial. Thus, the feed line/pipe for the second liquid stream may define a larger internal/diameter as compared to the outer diameter of the feed line/pipe for the first liquid stream, thereby permitting flow of the second liquid stream in a ring-shaped flow channel defined around the exterior of the feed line/pipe for the first liquid stream. In this way, mixing between the first and second liquid streams is avoided (or substantially minimized) until immediately prior to pressure intensification. Accordingly, premature interaction between the first and second liquids is advantageously avoided in this example of the coaxial feed feature/design and interaction between such liquid streams occurs in the mixing chamber/microreactor, e.g., at the nanoscale level. Alternative flow patterns may be employed, e.g., side-by-side feed lines/pipes, to minimize/prevent premature interaction and/or mixing without departing from the spirit or scope of the present disclosure.

As used herein, “about,” “approximately” and “substantially” are understood to refer to numbers in a range of numerals, for example the range of −10% to +10% of the referenced number, preferably −5% to +5% of the referenced number, more preferably −1% to +1% of the referenced number, most preferably −0.1% to +0.1% of the referenced number.

Furthermore, all numerical ranges herein should be understood to include all integers, whole or fractions, within the range. Moreover, these numerical ranges should be construed as providing support for a claim directed to any number or subset of numbers in that range. For example, a disclosure of from 1 to 10 should be construed as supporting a range of from 1 to 8, from 3 to 7, from 1 to 9, from 3.6 to 4.6, from 3.5 to 9.9, and so forth.

Without further elaboration, it is believed that one skilled in the art can use the preceding description to utilize the claimed inventions to their fullest extent. The examples and aspects disclosed herein are to be construed as merely illustrative and not a limitation of the scope of the present disclosure in any way. It will be apparent to those having skill in the art that changes may be made to the details of the above-described examples without departing from the underlying principles discussed. In other words, various modifications and improvements of the examples specifically disclosed in the description above are within the scope of the appended claims. For instance, any suitable combination of features of the various examples described is contemplated.

1. A high-shear mixing chamber for a high pressure fluid processor comprising:
an inlet chamber including an inlet hole and a bottom end;
an inlet plenum in fluid communication with the bottom end of the inlet chamber;
an outlet chamber including an outlet hole and a top end;
an outlet plenum in fluid communication with the top end of the outlet chamber; and
a microchannel connecting the inlet plenum to the outlet plenum, wherein a first portion of the microchannel has a first uniform depth, a second portion of the microchannel has a second uniform depth, and a third portion of the microchannel has a third uniform depth, wherein the first depth is different than the second depth, and wherein the first, second and third portions run parallel along a length of the microchannel between the inlet and outlet chambers.

2. The high-shear mixing chamber of claim 1, wherein the inlet chamber and/or the outlet chamber is vertically-disposed.

3. The high-shear mixing chamber of claim 1, wherein the inlet chamber and/or the outlet chamber is cylindrical.

4. The high-shear mixing chamber of claim 1, wherein the microchannel extends a length between the inlet and outlet chambers and wherein a width of the microchannel is greater than a width or diameter of the inlet chamber and a width or diameter of the outlet chamber, the width being perpendicular to the length.

5. The high-shear mixing chamber of claim 1, wherein the second portion is between the first and third portions, and wherein the first depth is equal to the third depth.

6. The high-shear mixing chamber of claim 1, wherein the third depth is different than the first depth and the second depth.

7. The high-shear mixing chamber of claim 1, wherein the first depth is consistent throughout the first portion, the second depth is consistent throughout the second portion, and the third depth is consistent throughout the third portion.

8. The high-shear mixing chamber of claim 1, wherein the second portion is between the first portion and the third portion, wherein the microchannel includes a first surface opposite a second surface, and wherein the first surface is stepped such that the second depth is greater than the first depth.

9. The high-shear mixing chamber of claim 1, wherein the second portion is between the first portion and the third portion, wherein the microchannel includes a first surface opposite a second surface, and wherein the first surface is stepped such that the second depth is less than the first depth.

10. The high-shear mixing chamber of claim 1, wherein a central region of an interior of the microchannel includes a plurality of corners, wherein each corner extends the length of the microchannel.

11. The high-shear mixing chamber of claim 1, wherein a central region of an interior of the microchannel includes a plurality of right-angled surfaces, wherein each right-angled surface extends the length of the microchannel.

12. The high-shear mixing chamber of claim 1, wherein the microchannel includes a first stepped surface opposite a second stepped surface, wherein each the first stepped surface and the second stepped surface includes a plurality of right angles in a central portion of the first and second stepped surfaces that each extend the length of the microchannel.

13. The high-shear mixing chamber of claim 1, wherein the first portion of the microchannel is directly adjacent the second portion of the microchannel.

14. The high-shear mixing chamber of claim 1, wherein the high-shear mixing chamber is at least partially constructed of at least one of a ceramic and diamond.

15. The high-shear mixing chamber of claim 1, wherein at least a portion of the interior of the high-shear mixing chamber is coated with polycrystalline diamond.

16. The high-shear mixing chamber of claim 1, configured to withstand an operating pressure within a range of 5,000-50,000 psi without failure.

17. (canceled)

18. (canceled)

19. A high-shear mixing chamber for a high pressure fluid processor comprising:
a vertically-disposed inlet chamber including an inlet hole and a bottom end;
an inlet plenum in fluid communication with the bottom end of the inlet chamber;
a vertically-disposed outlet chamber including an outlet hole and a top end;
an outlet plenum in fluid communication with the top end of the outlet chamber; and
a microchannel connecting the inlet plenum to the outlet plenum, wherein the microchannel extends a length from the inlet plenum to the outlet plenum and wherein a width of the microchannel is greater than a width of the inlet chamber and a width of the outlet chamber.

20. The high-shear mixing chamber of claim 19, wherein the inlet plenum has a width parallel to the width of the microchannel, and wherein the width of the microchannel is at least half of the width of the inlet plenum.

21. The high-shear mixing chamber of claim 19, a single microchannel connects the inlet plenum to the outlet plenum.

22. The high-shear mixing chamber of claim 19, wherein the microchannel includes a first surface opposite a second surface, wherein the first surface includes at least one first step that extends the length of the microchannel, the at least one first step extending towards or away from the second surface.

23. The high-shear mixing chamber of claim 22, wherein the second surface includes at least one second step that extends the length of the microchannel, the at least one second step extending towards or away from the first surface.

24. The high-shear mixing chamber of claim 19, wherein the microchannel has an aspect ratio (width:depth) of greater than or equal to 10:1.

25. (canceled)

26. (canceled)

27. A method of processing a material,
receiving the material at an inlet chamber in fluid communication with an inlet plenum; and
passing the material at a pressure in the range of 5,000 to 50,000 psi through a microchannel connecting the inlet plenum to an outlet plenum of an outlet chamber, wherein a first portion of the microchannel has a first uniform depth, a second portion of the microchannel has a second uniform depth, and a third portion of the microchannel has a third uniform depth, wherein the first depth is different than the second depth, and wherein the first, second and third portions run parallel along a length of the microchannel between the inlet and outlet chambers.

28. A method of processing a material,
receiving the material at a vertically disposed inlet chamber in fluid communication with an inlet plenum; and
passing the material at a pressure in the range of 5,000 to 50,000 psi through a microchannel connecting the inlet plenum to an outlet plenum, wherein the microchannel extends a length from the inlet plenum to the outlet plenum and wherein a width of the microchannel is greater than a width of the inlet chamber and a width of the outlet chamber.
